(19) United States
(12) Patent Application Publication
(10) Pub. No.: US 2012/0124263 A1
(43) Pub. Date: May 17, 2012

(54) ALLOCATING GRANT CHANNEL RESOURCES

(75) Inventors: Yan Zhou, San Diego, CA (US); Ian Jeong, Boulder, CO (US); Farhad Meshkati, San Diego, CA (US); Mehmet Yavuz, San Diego, CA (US)

(73) Assignee: QUALCOMM Incorporated, San Diego, CA (US)

(21) Appl. No.: 13/106,823

(22) Filed: May 12, 2011

Related U.S. Application Data
(60) Provisional application No. 61/334,960, filed on May 14, 2010.

(51) Int. Cl. G06F 13/364

(52) U.S. Cl. 710/240

(57) ABSTRACT

Grant channel resources are allocated based on the number of access terminals that use different types of transmission time intervals (TTIs) for data transmissions. For example, if the number of access terminals using a first type of TTI exceeds the number of access terminals using a second type of TTI, more grant channel resources are allocated to the access terminals that use the first type of TTI.

### CLAIM OF PRIORITY

This application claims the benefit of and priority to commonly owned U.S. Provisional Patent Application No. 61/334,960, filed May 14, 2010, and assigned Attorney Docket No. 101635P1, the disclosure of which is hereby incorporated by reference herein.

### BACKGROUND

1. Field

This application relates generally to wireless communication and more specifically, but not exclusively, to allocating wireless network resources.

2. Introduction

A wireless communication network may be deployed over a defined geographical area to provide various types of services (e.g., voice, data, multimedia services, etc.) to users within that geographical area. In a typical implementation, access points (e.g., corresponding to different cells) are distributed throughout a network to provide wireless connectivity for access terminals (e.g., cell phones) that are operating within the geographical area served by the network.

An access terminal communicates with an access point via transmissions on so-called forward and reverse links. The forward link (or downlink) refers to a communication link from an access point to an access terminal, and the reverse link (or uplink) refers to a communication link from an access terminal to an access point. A given communication link, in turn, comprises various control and data channels.

Some wireless networks employ a grant-based transmission control mechanism whereby an access point controls whether and/or how an access terminal is to transmit on an uplink channel. For example, a high-speed uplink packet access (HSUPA) system employs enhanced dedicated channel (E-DCH) absolute grant channels (E-AGCH) to control access terminal transmissions on an E-DCH dedicated physical data channel (E-DPDCH).

### SUMMARY

A summary of several sample aspects of the disclosure follows. This summary is provided for the convenience of the reader and does not wholly define the breadth of the disclosure. For convenience, the term some aspects may be used herein to refer to a single aspect or multiple aspects of the disclosure.

The disclosure relates in some aspects to an improved scheme for allocating grant channel resources. In some aspects, grant channel resources are allocated based on the number of access terminals that use different types of transmission time intervals (TTIs) for data transmissions. For example, if the number of access terminals using a first type of TTI exceeds the number of access terminals using a second type of TTI, more grant channel resources are allocated to the access terminals that use the first type of TTI.

Accordingly, in some implementations, a grant channel allocation scheme comprises: receiving transmission time interval information for a plurality of access terminals; determining a first quantity of the access terminals that transmit based on a first transmission time interval, wherein the determination of the first quantity is based on the received transmission time interval information; determining a second quantity of the access terminals that transmit based on a second transmission time interval, wherein the determination of the second quantity is based on the received transmission time interval information; and allocating grant channel resources of an access point to the access terminals based on the determination of the first and second quantities.

The disclosure relates in some aspects to an improved scheme for allocating E-AGCH resources. In conventional HSUPA systems, the number of E-AGCH resources allocated by an access point is typically fixed for 2 millisecond (ms) TTIs and 10 ms TTIs. In many cases, however, HSUPA-capable access terminals predominantly employ the 10 ms TTI. Consequently, the allocated 2 ms TTI E-AGCH resources are underutilized in these cases. In accordance with the teachings herein, E-AGCH resources are partitioned according to demand per TTI type. That is, the TTI with more users (access terminals) is allocated more E-AGCH resources.

Advantageously, grant channel resources are used more efficiently through the use of the disclosed allocation scheme. For example, when more grant channels are assigned to the access terminals using a given TTI type, the access point will be able to send grants more frequently (e.g., in parallel over multiple grant channels) to those access terminals. Since there are more access terminals using this TTI type than any other TTI type, the resources are allocated where they are most needed and grants are provided with less latency. In contrast, in a conventional scheme where a fixed grant channel allocation is employed, grant channel resources tend to be underutilized whenever there are more access terminals using one TTI type versus another TTI type.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of several sample aspects of a communication system adapted to allocate grant channel resources;

FIG. 2 is a flowchart of several sample aspects of operations performed in conjunction with allocating grant channel resources;

FIG. 3 is a flowchart of several sample aspects of operations performed in conjunction with maintaining a list of TTI type information;

FIG. 4 is a flowchart of several sample aspects of operations performed in conjunction with allocating grant channel resources;

FIG. 5 is a simplified block diagram of several sample aspects of components that may be employed in communication nodes;

FIG. 6 is a simplified diagram of a wireless communication system;

FIG. 7 is a simplified diagram of a wireless communication system including femto nodes;

FIG. 8 is a simplified diagram illustrating coverage areas for wireless communication;

FIG. 9 is a simplified block diagram of several sample aspects of communication components; and

FIG. 10 is a simplified block diagram of several sample aspects of an apparatus configured to provide resource allocation as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

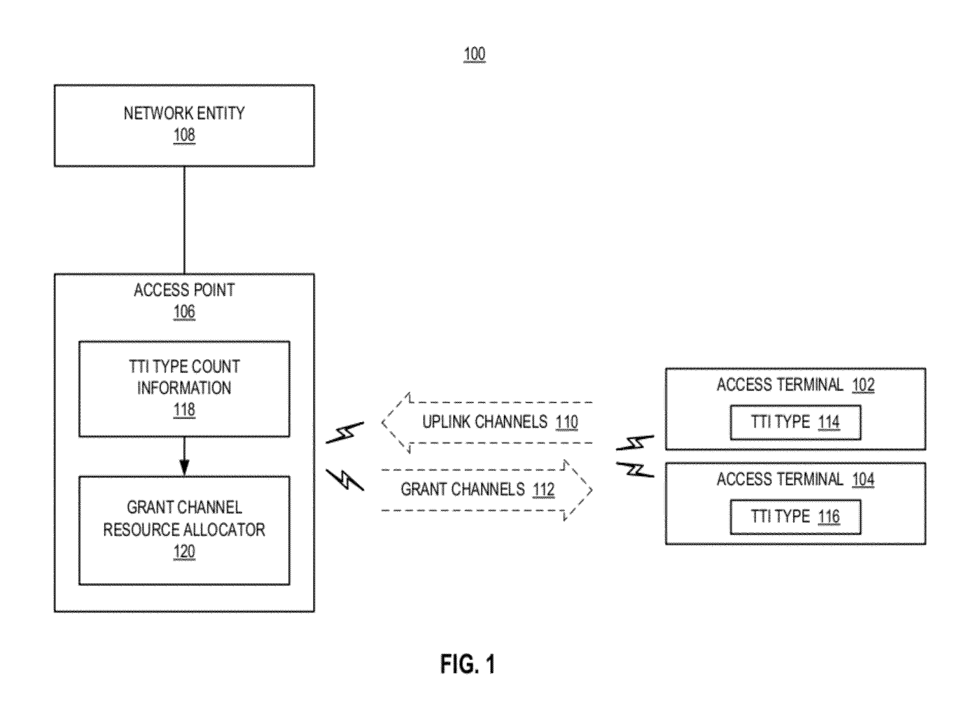

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, femto cells, and so on, while access terminals may be referred to or implemented as user equipment (UEs), mobile stations, and so on.

Access points in the system 100 provide access to one or more services (e.g., network connectivity) for one or more wireless terminals (e.g., the access terminals 102 and 104) that may be installed within or that may roam throughout a coverage area of the system 100. For example, at various points in time the access terminal 102 may connect to an access point 106 or some access point in the system 100 (not shown). Each of these access points communicate with one or more network entities (represented, for convenience, by the network entity 108) to facilitate wide area network connectivity.

These network entities may take various forms such as, for example, one or more radio and/or core network entities. Thus, in various implementations the network entities may represent functionality such as at least one of: network management (e.g., via an operation, administration, management, and provisioning entity), call control, session management, mobility management, gateway functions, interworking functions, or some other suitable network functionality. In some aspects, mobility management relates to: keeping track of the current location of access terminals through the use of tracking areas, location areas, routing areas, or some other suitable technique; controlling paging for access terminals; and providing access control for access terminals. Also, two of more of these network entities may be co-located and/or two or more of these network entities may be distributed throughout a network.

The access terminals 102 and 104 send data to the access point 106 via uplink channels 110 (represented by the corresponding dashed arrow for convenience). A given access terminal transmits on the uplink according to a selected TTI. For example, an access terminal that uses a 10 ms TTI performs its uplink channel transmissions at 10 ms intervals (e.g., the transmission of a given packet takes place within the 10 ms interval). In contrast, an access terminal that uses a 2 ms TTI performs its uplink channel transmissions at 2 ms intervals.

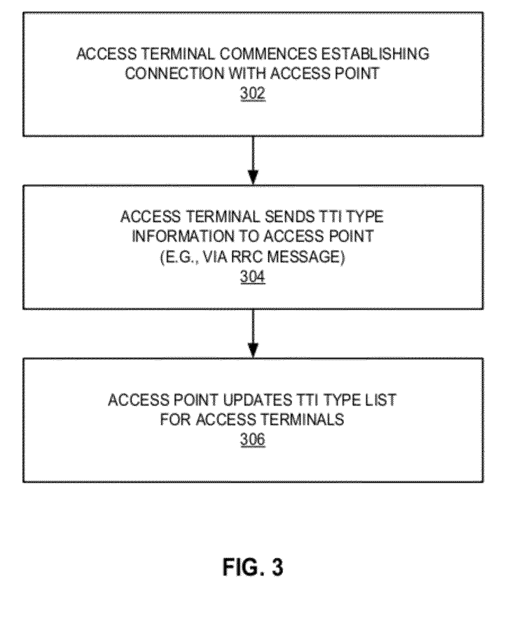

Accordingly, the access terminals 102 and 104 and any other access terminals (not shown) that associate with (e.g., connect to) the access point 106 each use a TTI of a designated type. Specifically, the access terminal 102 uses the TTI type 114 (e.g., 10 ms) and the access terminal 104 uses the TTI type 116 (e.g., 2 ms) in this example. Different types of TTIs (e.g., different durations) and different numbers of TTIs (e.g., 3 or more) may be employed in other implementations. As discussed in more detail below in conjunction with FIG. 3, the access point 106 determines the TTI type used by each of these access terminals and stores corresponding TTI type count information 118 at the access point 106.

The access point 106 employs request/grant-based scheduling to control transmissions on the uplink channels 110. In a typical case, the access point 106 uses scheduling to, for example, control the transmit power (and, hence, the rate) at which data is sent on the uplink channels 110 and mitigate potential interference between uplink transmissions by different access terminals. Here, an access terminal sends a message (e.g., a scheduling information message sent via E-DPDCH) to the access point 106 that indicates that the access terminal has data to send via one or more of the uplink channels 110 or the access terminal sends an indication (e.g., a happy bit) to request a change in an uplink transmission parameter (e.g., transmit power, rate, etc.). In response, the access point 106 sends a grant to the requesting access terminal on a grant channel. In a typical example, a grant issued by the access point 106 specifies the power level that the requesting access terminal is to use when transmitting on one of the uplink channels 110.

In accordance with the teachings herein, the access point 106 employs a grant channel resource allocator 120 that allocates grant channel resources for the access point 106 based on the number of access terminals for each TTI type as indicated by the TTI type count information 118. Here, the grant channel resources correspond to, for example, the number of grant channels that are established for sending grants. Accordingly, the grant channel resource allocator 120 allocates one or more grant channels for a first set of access terminals that use one type of TTI, allocates one or more other grant channels for a second set of access terminals that use another type of TTI, and so on; where the allocation is based on the relative number of access terminals in each set.

In a high speed packet access system (e.g., HSUPA), the absolute grant channel (E-AGCH) is a shared channel that an access point uses to send grants to its access terminals. Here, the transmission grant information for different access terminals (e.g., grant messages) is sent over a given grant channel on a time division multiplexed (TDM) basis. Each grant includes a 5-bit index that specifies the power level (e.g., an absolute power level relative to E-DPDCH) at which a requesting access terminal is allowed to transmit. The grants for different access terminals are encoded so that only the target access terminal is able to decode its grant. In addition, the access point sends the grants based on the TTI. Thus, for a 10 ms TTI E-AGCH, grants are sent every 10 ms, while grants are sent every 2 ms for a 2 ms TTI E-AGCH. Thus, the 2 ms TTI more efficiently supports higher data rates since the grants are more responsive (e.g., the grant latency is lower).

In accordance with the teachings herein, E-AGCH resources are more effectively partitioned among the 10 ms and 2 ms TTI types based on the number of access terminals for each TTI type. If one TTI type has more access terminals than the other, more E-AGCHs are configured for that TTI type to reduce the receiving delay of the absolute grant. The reduction of this delay may be proportional to the increased number of E-AGCHs. As a simple example, if an access point only has 10 ms users (e.g., connected access terminals), the grant-receiving delay is reduced by half if all E-AGCHs are configured as the 10 ms TTI type instead of split evenly between both TTI types. The allocation of more E-AGCHs and the resulting decrease in grant-receiving delay is advantageous in several use cases.

In a first use case, the allocation of additional E-AGCHs reduces the grant-receiving delay since more absolute grants can be sent in parallel over the E-AGCHs. This, in turn, results in a quicker release of traffic congestion when the system load is high. For example, the access point measures the total power its sees on the uplink versus thermal noise (commonly referred to as the rise-over-thermal (RoT)) to determine how much transmit power to allocate to access terminals for uplink transmissions. If the access point detects a sudden rise of RoT, the access point reduces the traffic-to-pilot (T2P) for each in-cell access terminal to keep the RoT below a defined threshold. In this case, the allocation of additional E-AGCHs decreases the amount of time it takes to reduce the T2Ps because the access point is able to send the grant-reduction commands in parallel to the in-cell access terminals. As a specific example, doubling the E-AGCH number can reduce the T2P reduction time by half.

In a second use case, the allocation of additional E-AGCHs allows more access terminals to simultaneously change their T2Ps so that radio resources (e.g., RoT) are more quickly released from the access terminals with poorer channels and assigned to the access terminals with better channels. For example, when proportional fair scheduling is employed, the T2P may be increased for access terminals with good channels and decreased for access terminals with bad channels. Advantageously, this transition can occur relatively quickly because multiple E-AGCHs can be used to change the T2Ps up and down simultaneously.

The third use case relates to a situation where the access point (or some other network entity) has limited memory resources for storing received data on the E-DPDCH for the uplink. In this case, the transmission rate of each user (e.g., access terminal) is constrained to satisfy this memory resource limitation. This can be accomplished by constraining the T2P and, hence, the transport block size (TBS) via E-AGCH (e.g., which specifies the transmit power to be used by the access terminal). That is, E-AGCH is a very effective mechanism for controlling an access terminal's T2P and, hence, E-DPDCH memory usage. However, the E-AGCH command is only valid for 1 HARQ cycle (40 ms for the 10 ms TTI case). After the expiration of that HARQ cycle, the grant procedure will use the E-DCH relative grant channel (E-RGCH) command, which may not accurately constrain the T2P since the E-RGCH command simply uses a fixed step size for controlling access terminal transmit power. Therefore, it is advantageous to provide a sufficient number of E-AGCHs so that each access terminal's grant will always remain under the tight control of E-AGCH, as opposed to the looser control of E-RGCH. Also, the allocation of additional E-AGCHs generally improves the speed at which existing users' (e.g., connected access terminals') T2P and memory usage are reduced. Consequently, this enables memory resources to be released more quickly for new users (e.g., newly connected access terminals).

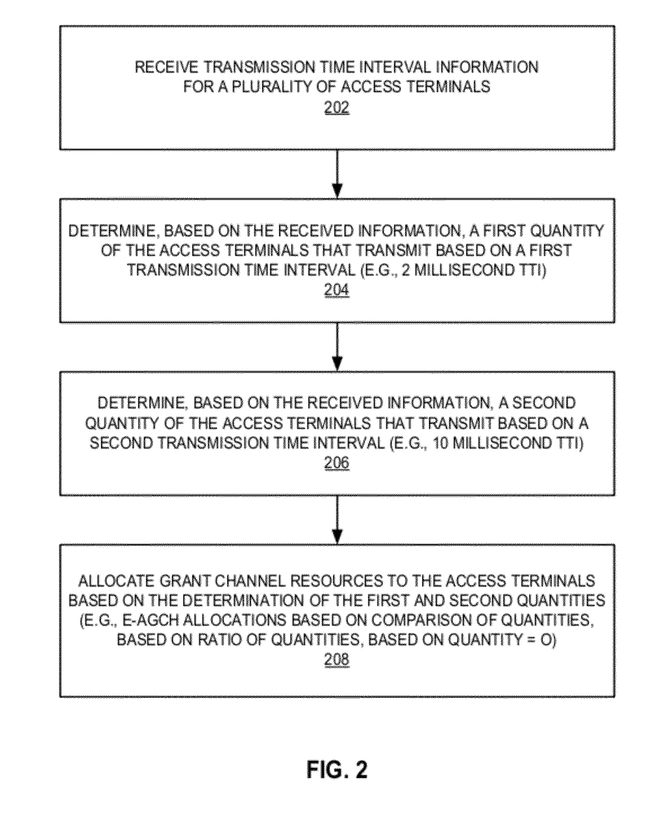

FIG. 2 illustrates an example of grant channel resource allocation operations in accordance with the teachings herein. For purposes of illustration, the operations of FIG. 2 (or any other operations discussed or taught herein) may be described as being performed by specific components. For example, the operations of FIG. 2 are described from the perspective of an access point that allocates resources to associated access terminals. These operations may be performed by other types of components and may be performed using a different number of components in other implementations. Also, it should be appreciated that one or more of the operations described herein may not be employed in a given implementation. For example, one entity may perform a subset of the operations and pass the result of those operations to another entity.

As represented by block 202, at various points in time, an access point receives TTI information for a plurality of access terminals. For example, in some implementations, the access point receives TTI information from a given access terminal when that access terminal connects to the access point. The access point then maintains a list of this information such that over time the access point determines the TTI types used by access terminals that are currently being served or were previously served by the access point. An example of these operations is described in more detail below in conjunction with FIG. 3.

A different number of TTI types may be employed in different implementations. In a typical example (e.g., a UMTS HSUPA implementation), two TTI types are supported: a 10 ms TTI and a 2 ms TTI.

As represented by block 204, the access point determines a first quantity of the access terminals that transmit based on a first TTI (e.g., the 2 ms TTI). This determination is based on the information received at block 202. For example, in some implementations, the access point processes the list of TTI information (e.g., periodically, whenever there is a change in the information, or in some other manner) to determine how many of the access terminals identified in the list use the first TTI.

As represented by block 206, the access point determines a second quantity of the access terminals that transmit based on a second TTI (e.g., the 10 ms TTI). This determination also is based on the information received at block 202. For example, in some implementations, the access point processes the list of TTI information (e.g., periodically, whenever there is a change in the information, or in some other manner) to determine how many of the access terminals identified in the list use the second TTI.

As represented by block 208, the access point allocates its grant channel resources to the access terminals based on the determination of the first and second quantities. This allocation is performed in different ways in different implementations.

In some implementations, the allocation is based on a comparison of the first and second quantities. For example, the operations of block 208 may involve comparing the identified first and second quantities and allocating the grant channel resources based on the comparison. In this case, more resources are allocated to the TTI associated with the larger of the two quantities

In some implementations, the allocation is based on a ratio of the first and second quantities. As a simple example, if twice as many access terminals use a 10 ms TTI versus a 2 ms TTI, twice as many grant channels are allocated for the 10 ms TTI access terminals. As another simple example, if the same number of access terminals use a 10 ms TTI versus a 2 ms TTI, the same number of grant channels are allocated for the 10 ms TTI access terminals and the 2 ms TTI access terminals.

In some implementations, the allocation is based on whether one of the quantities is zero. For example, if the first quantity is zero (e.g., there are no access terminals using the 2 ms TTI), all of the grant channel resources are allocated to the access terminals that transmit based on the second TTI (e.g., the 10 ms TTI).

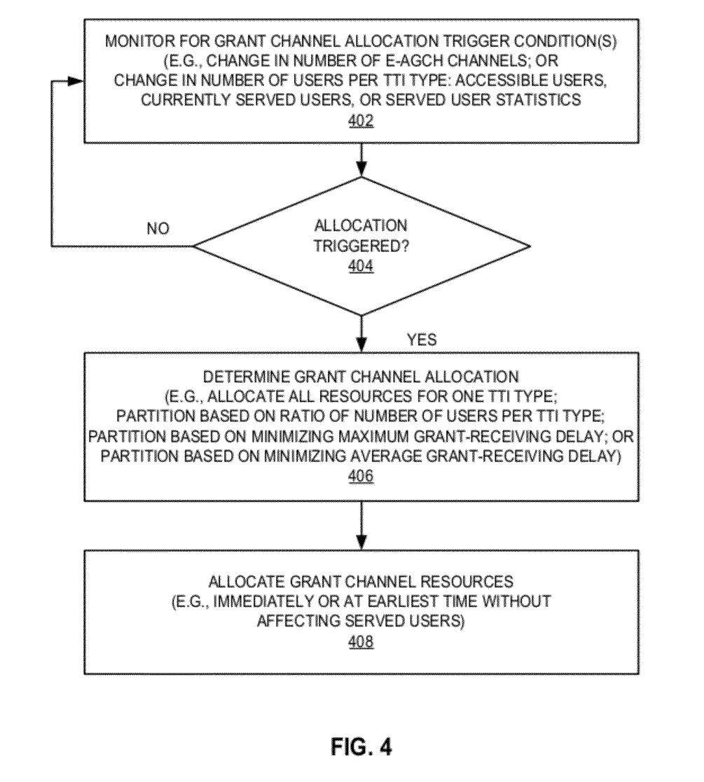

In some implementations, the allocation is performed in a manner that attempts to minimize grant-receiving delay. For example, grant channel resources are allocated to minimize a maximum delay associated with grant reception at the access terminals. As discussed in more detail below in conjunction with block 406 of FIG. 4, the minimization of this maximum delay is based on the first and second quantities. As another example, in some implementations, grant channel resources are allocated to minimize an average delay associated with grant reception at the access terminals. As discussed in more detail below in conjunction with block 406 of FIG. 4, the minimization of this average delay is based on the first and second quantities.

FIG. 3 illustrates an example of operations performed to maintain TTI information. For purposes of illustration, these operations are described from the perspective of an access point that receives TTI information from access terminals. These operations may be performed by other types of components in other implementations.

As represented by block 302, at some point in time, an access terminal commences establishing a connection with an access point that supports grant channel resource allocation as taught herein. For example, as the access terminal moves into the coverage of the access point, the access terminal may be handed-over to the access point (e.g., in active mode) or perform a cell reselection to the access point (e.g., in idle mode).

As represented by block 304, in conjunction with establishing this connection, the access terminal sends TTI type information to the access point. For example, in a UMTS-based system, an access terminal (i.e., a UE) sends a radio resource control (RRC) connection setup request message when establishing a connection with an access point (i.e., a base station). This RRC connection setup message includes an identifier of the access terminal (i.e., a UE identity). In addition, the access terminal sends an RRC connection setup complete message to the access point to complete the connection. This RRC connection setup complete message includes the E-DCH category for the access terminal which specifies whether the access terminal supports a 10 ms TTI and/or a 2 ms TTI.

As represented by block 306, the access point updates its TTI type list based on the information received at block 304. For example, in some implementations, the access terminal builds a table including an identifier and the E-DCH category for each accessible access terminal The access terminal identifier comprises an international mobile subscriber identity (IMSI), an international mobile equipment identity (IMEI), or some other suitable identifier.

The operations of blocks 302-306 are repeated each time an access terminal establishes a connection with the access point. Accordingly, the access point will repeatedly update the TTI type list over time. Moreover, the access point may include information in the list that indicates any current relationship and any prior relationship of the access terminals with the access point. For example, in some implementations, for each access point in the list, the list includes an indication of whether that access terminal is currently being served by the access point and/or whether that access terminal was recently served by the access point.

Also, in some implementations, the list comprises an accessible user list, whereby the access point limits the access terminals in the list to, for example, nearby access terminals that are allowed to access service via the access point. For example, in a case where the access point supports restricted association (e.g., the access point is a femto cell that is associated with a closed subscriber group), the access point may only include in the list: access terminals that the access point is able to detect and that are currently authorized for access (e.g., that are members of the closed subscriber group). In some implementations, the access point only includes in the list: access terminals that are currently authorized for access. Here, the authorized access terminals may be learned by the access point from information received from the network or from previous access terminal access admission experience.

Referring now to FIG. 4, a more detailed example of operations performed by an access point to allocate grant channel resources is described. For purposes of illustration, these operations are also described in the context of a HSUPA-based system where an access point allocates E-AGCH resources based on the number of users (e.g., access terminals) that use a 10 ms TTI versus a 2 ms TTI. In particular, these operations describe triggering an E-AGCH allocation (e.g., partition), determining the E-AGCH allocation, and executing the E-AGCH allocation. It should be understood that the disclosed operations are applicable to other implementations that allocate other types of resources.

As represented by blocks 402 and 404, the access point monitors for grant channel allocation trigger conditions to determine whether to allocate (e.g., reallocate) its grant channel resources. In some implementations, the allocation of the grant channel resources is triggered based on a change in the quantity of grant channels for the access point. In some implementations, the allocation of the grant channel resources is triggered based on a change in the quantity of access terminals served by the access point in each TTI type. In some implementations, the allocation of the grant channel resources is triggered based on a change in the quantity of access terminals currently allowed to access the access point (i.e., the currently accessible access terminals).

A detailed example for triggering an E-AGCH partition follows. The E-AGCH partition is triggered if Total_AGCH_Number, User_Number_{—}2ms, or User_Number_{—}10ms has changed. Here, Total_AGCH_Number is the total E-AGCH number, User_Number_{—}2ms is the number of users with 2 ms TTI, and User_Number_{—}10ms is the number of users with 10 ms TTI.

For a trigger due to a change of Total_AGCH_Number, the partition is triggered by any change in the total number of E-AGCHs. In some implementations, Total_AGCH_Number=min{Num_Avail_Codes, Num_Avail_Chains}. The parameter Num_Avail_Codes represents the number of channelization codes that are available for use for E-AGCH. The parameter Num_Avad_Chains represents the number of encoding and modulation chains that are available for use for E-AGCH. For example, in some cases this is equal to the total number of encoding and modulation chains at the access point minus the chains used for downlink traffic transmissions.

For a trigger due to a change of the number of users for a given TTI type, the E-AGCH partition is triggered either by a change in the total number of users for the 2 ms TTI or the total number of users for the 10 ms TTI. Three examples follow.

In the first example, the trigger is based on the number of accessible users. Here, it is assumed that the access point only allows a certain number of users to access the access point. For example, in some implementations, the access point monitors for signals from nearby users and determines which of these users is allowed access. The access point then defines a list of accessible users based on this determination. In some implementations, the access point obtains the list of accessible users either from the network or from previous user access admission experience. The above schemes may be employed, for example, for an access point with restricted access (e.g., a femto access point).

In this case, User_Number_{—}2ms is defined as the number of accessible users supporting 2 ms TTI, and User_Number_{—}10ms is defined as the number of accessible users supporting 10 ms TTI. The partition will be triggered once either number is changed. An example of how the access point obtains information to determine the number of accessible users per TTI type is described above at FIG. 3.

In the second example, User_Number_{—}2ms and User_Number_{—}10ms are defined as the number of currently served 2 ms TTI and 10 ms TTI users, respectively. The partition will be triggered once either number is changed.

In the third example, User_Number_{—}2ms and User_Number_{—}10ms are defined as the maximum or average number of 2 ms TTI and 10 ms TTI users served by the access point within the previous T1 seconds. Both User_Number_{—}2ms and User_Number_{—}10ms will be updated every T1 seconds, and the partition will be triggered if either number changes. The period T1 will determine the partition update frequency.

To update User_Number_{—}2ms and User_Number_{—}10ms, the access point records the number of currently served users per TTI type every T2 seconds, where T2<T1. The maximum or average number of users per TTI type is then computed based on the recorded user numbers within the last T1 seconds.

As represented by block 406 of FIG. 4, if the trigger condition of block 404 is met, the access point determines the grant channel allocation. For the above E-AGCH example, the number of E-AGCH per TTI type is recomputed if Total_AGCH_Number, User_Number_{—}2ms, or User_Number_{—}10ms has changed. Two recomputation scenarios are described for a case with zero accessible users and a case with non-zero accessible users. In these scenarios, Total_AGCH_Number is assumed to be at least two to guarantee that at least one E-AGCH is available for each TTI type if the accessible users have both TTI types.

For the zero accessible user scenario, one of the TTI types does not have any accessible users. In this case, since the access point will not serve users with the other TTI type, all E-AGCHs are allocated to the TTI type with the non-zero number of accessible users.

For the non-zero accessible user scenario, each of the TTI types has at least one accessible user. In this case, the base station reserves one E-AGCH for each TTI type and partitions the remaining E-AGCHs between the two TTI types. This reservation is to prevent the case that a new user arrives but all E-AGCHs are configured for the other TTI type and are used by existing users. In such a case, the access point may reconfigure one used E-AGCH for the new user's TTI type. However, such a reconfiguration would cause undesirable delay and signaling. Alternatively, the access point may elect to not employ the above reservation scheme. In such a case, the access point partitions all E-AGCHs between the two TTI types as needed for reconfiguration for a new user.

Three implementation examples for the non-zero accessible user scenario are described below. In the first example, the partition of the remaining E-AGCHs is based on the ratio of the number of users for each TTI type. In the second and third examples, the partition of the remaining E-AGCHs is based on minimizing the maximum/average grant-receiving delay per TTI type.

Referring to the first example, this scheme tries to make the number of E-AGCHs per TTI type proportional to the number of users per TTI type, so that the TTI type with more users will have more E-AGCHs. In some implementations, the number of E-AGCHs in each TTI type is computed as follows:

$$AGCH\_Number \_ 2 ms = 1 + ⌊ \frac{\begin{matrix}( Total\_AGCH \_Number - 2 ) \times \\ User\_Number \_ 2 ms\end{matrix}}{User\_Number \_Total} ⌋$$

$$AGCH\_Number \_ 10 ms = Total\_AGCH \_Number - AGCH\_Number \_ 2 ms$$

Here, User_Number_Total=User_Number_{—}2ms+User_Number_{—}10ms, and the other inputs are obtained from the step of triggering the E-AGCH partition. In the above equation, one E-AGCH is reserved for 2 ms TTI (also implicitly for 10 ms TTI). The number of remaining E-AGCHs is Total_AGCH_Number−2, which is partitioned based on the ratio of the number of users per TTI type. If the access point elects to not use the reservation scheme (as discussed above), the equation for AGCH_Number_{—}2ms is modified by removing the “1+” and “−2” terms.

Referring to the second example, this scheme tries to minimize the maximum grant-receiving delay per TTI type. The grant-receiving delay per TTI type is defined as the duration between the time that the access point's scheduler starts sending the absolute grants to all users in that TTI type (e.g., in a TDM manner over at least one shared channel) and the time that all of the users have received their respective absolute grants. In some embodiments, the number of E-AGCHs per TTI type is computed as follows:

$$AGCH\_Number \_ 2 ms = 1 + arg {min}_{x} max \{ {T}_{2 m s} , {T}_{10 m s} \} , \\ s . t . 0 \leq X \leq Total\_AGCH \_Number - 2$$

$$AGCH\_Number \_ 10 ms = Total\_AGCH \_Number - AGCH\_Number \_ 2 ms$$

where:

$${T}_{2 m s} = 2 ms \times ⌈ \frac{User\_Number \_ 2 ms}{X + 1} ⌉$$

$${T}_{10 m s} = 10 ms \times ⌈ \frac{User\_Number \_ 10 ms}{Total\_AGCH \_Number - ( X + 1 )} ⌉$$

In the above equations, one E-AGCH is reserved for the 2 ms TTI (also implicitly for the 10 ms TTI), T₂ₘₛ and T₁₀ₘₛ represent the grant-receiving delays for the 2 ms and 10 ms TTI types, respectively. The parameter X is the number of remaining E-AGCHs allocated to the 2 ms TTI and is optimized to minimize the maximum of both T₂ₘₛ and T₁₀ₘₛ. According to the expressions of T₂ₘₛ and T₁₀ₘₛ, for the same User_Number_{—}2ms and User_Number_{—}10ms, the grant-receiving delay per TTI type will decrease if that TTI type has more E-AGCHs, since those E-AGCHs can simultaneously send grants to different users. If the access point elects to not use the reservation scheme (as discussed above), X can be defined as the total number of E-AGCHs allocated to the 2 ms TTI. Accordingly, the terms “1+” and “−2” can be removed from the equation for AGCH_Number_{—}2ms, and the term “X+1” can be replaced by “X” in the equations for both T₂ₘₛ and T₁₀ₘₛ. In addition, T₂ should be set to zero if User_Number_{—}2ms is zero, and T₁₀ₘₛ should be set to zero if User_Number_{—}10ms is zero,

Referring to the third example, this scheme tries to minimize the average grant-receiving delay per TTI type. The expressions of AGCH_Number_{—}2ms and AGCH_Number_{—}10ms are the same in this example as those in the second example except that the maximum is replaced by the average.

As represented by block 408 of FIG. 4, the access point allocates the grant channel resources according to the determination of block 406. For the above E-AGCH example, after obtaining the updated E-AGCH number per TTI type, the access point reconfigures the E-AGCHs based on the updated numbers. The E-AGCH reconfiguration is either executed immediately or at the earliest time without affecting served users, as elaborated below.

For immediate E-AGCH reconfiguration, E-AGCHs are immediately reconfigured once the partition is updated. Here, it is assumed that each user can only monitor one E-AGCH. Some implementations follow the two step reconfiguration procedure that follows when the access point is serving users.

In step 1, an E-AGCH is released from one TTI type. If the updated E-AGCH number for one TTI type decreases, the access point only keeps E-AGCHs according to the updated number and releases any other E-AGCHs. Accordingly, the users served by these other E-AGCHs will be shifted to the remaining E-AGCHs. The shifting may be achieved by reconfiguring the E-AGCH channelization code monitored by each user to one of the remaining E-AGCH channelization codes through the use of RRC signaling. In one example, the shifting criterion attempts to equalize the number of users served by each remaining E-AGCH.

In step 2, a released E-AGCH is reallocated to the other TTI type. When the user shifting is done, the released E-AGCHs are reconfigured to the other TTI type, which now has a larger updated E-AGCH number. Next, one or more users with this TTI type are shifted to the reconfigured E-AGCHs. In one example, the shifting criterion attempts to equalize the number of users served by each E-AGCH configured for this TTI type.

If the access point is not serving any users, the above two step process need not be employed. Rather, in this case, the E-AGCH reconfiguration can be performed immediately because the E-AGCH resources are free to be assigned to any users.

In the above immediate reconfiguration scheme, users are first shifted to remaining E-AGCHs so that the E-AGCHs allocated for these users can be released. This user shifting will cause additional RRC signaling which may be undesirable in some implementations. Alternatively, E-AGCH reconfiguration can be done at the earliest time without affecting served users. For example, E-AGCH reconfiguration can be delayed until a time when the unused E-AGCH number for one TTI type is greater than or equal to the E-AGCH number to be released from that TTI type. Alternatively, the E-AGCH reconfiguration can be done one-by-one at the earliest time when an E-AGCH becomes unused. As an extreme case, E-AGCH reconfiguration can be delayed until a time when the access point not is serving any users. In this case, no user shifting is required.

The teachings herein may be implemented in a various types of devices (e.g., access points, access terminals, etc). In some cases, grant channel resource allocation is employed in an implementation where the access point provides coverage for a smaller area than a conventional macro access point. For example, in some implementations, a femto access point (e.g., a femto cell, a Home NodeB, a Home eNodeB, etc.) or a pico access point allocates grant channel resources in the manner taught herein for any access terminals that are allowed to access service via that access point. In such a case, the access point may allocate a relatively large number of grant channels. Here, because of the limited coverage of the access point, the access point is free to use a large number of channels codes since the use of these codes will not negatively impact other entities in the network to a significant degree. Hence, the access point is able to allocate a large number of grant channels (e.g., E-AGCHs) and thereby tightly control the uplink transmissions of the access terminals, instead of relying on a relative grant channel (e.g., E-RGCH). Here, the access point may elect to activate additional grant channels to counteract one or more of the problems described above in conjunction with FIG. 1 (e.g., upon detecting congestion, poor channels, or memory usage issues).

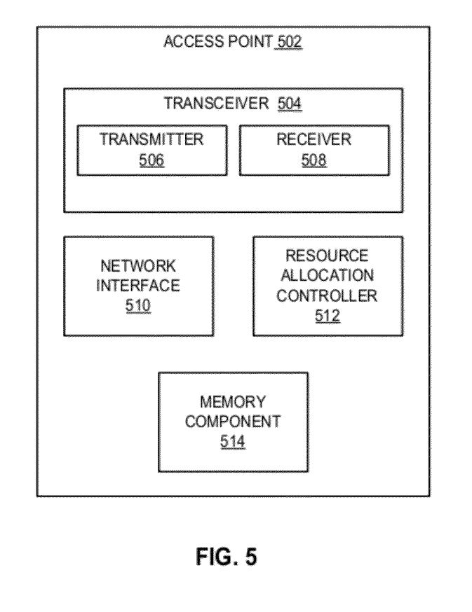

FIG. 5 illustrates several sample components (represented by corresponding blocks) that may be incorporated into nodes such as an access point 502 (e.g., corresponding to the access point 106 of FIG. 1) to perform allocation-related operations as taught herein. The described components also may be incorporated into other nodes in a communication system. For example, other nodes in a system may include components similar to those described for the access point 502 to provide similar functionality. Also, a given node may contain one or more of the described components. For example, an access point may contain multiple transceiver components that enable the access point to operate on multiple carriers and/or communicate via different technologies.

As shown in FIG. 5, the access point 502 includes one or more transceivers (as represented by a transceiver 504) for communicating with other nodes. Each transceiver 504 includes a transmitter 506 for sending signals (e.g., messages, indications, grants, indications of allocated grant channel resources) and a receiver 508 for receiving signals (e.g., messages, indications, TTI information, requests).

The access point 502 also includes a network interface 510 for communicating with other nodes (e.g., network entities). For example, the network interface 510 may be configured to communicate with one or more network entities via a wire-based or wireless backhaul. In some aspects, the network interface 510 may be implemented as a transceiver (e.g., including transmitter and receiver components) configured to support wire-based or wireless communication.

The access point 502 also includes other components that are used in conjunction with allocation-related operations as taught herein. For example, the access point 502 includes a resource allocation controller 512 for allocating resources (e.g., determining quantities of access terminals, allocating grant channel resources, triggering the allocation of the grant channel resources) and for providing other related functionality as taught herein. The access point 502 also includes a memory component 514 (e.g., including a memory device) for maintaining information (e.g., TTI information, list of accessible access terminals).

The components of FIG. 5 may be implemented in various ways. In some implementations the components of FIG. 5 are implemented in one or more circuits such as, for example, one or more processors and/or one or more ASICs (which may include one or more processors). Here, each circuit (e.g., processor) may use and/or incorporate memory for storing information or executable code used by the circuit to provide this functionality. For example, some of the functionality represented by block 504 and some or all of the functionality represented by blocks 510-514 may be implemented by a processor or processors of an access point and memory of the access point (e.g., by execution of appropriate code and/or by appropriate configuration of processor components).

As mentioned above, in some implementations, the teachings herein are employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a femto access point. It should be appreciated that the teachings herein may be applicable to nodes associated with other types of coverage areas. For example, a pico access point may provide coverage (e.g., coverage within a commercial building) over an area that is smaller than a macro area and larger than a femto area. In various applications, other terminology may be used to reference a macro access point, a femto access point, or other access point-type nodes. For example, a macro access point may be configured or referred to as an access node, base station, access point, eNodeB, macro cell, and so on. Also, a femto access point may be configured or referred to as a Home NodeB, Home eNodeB, access point base station, femto cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

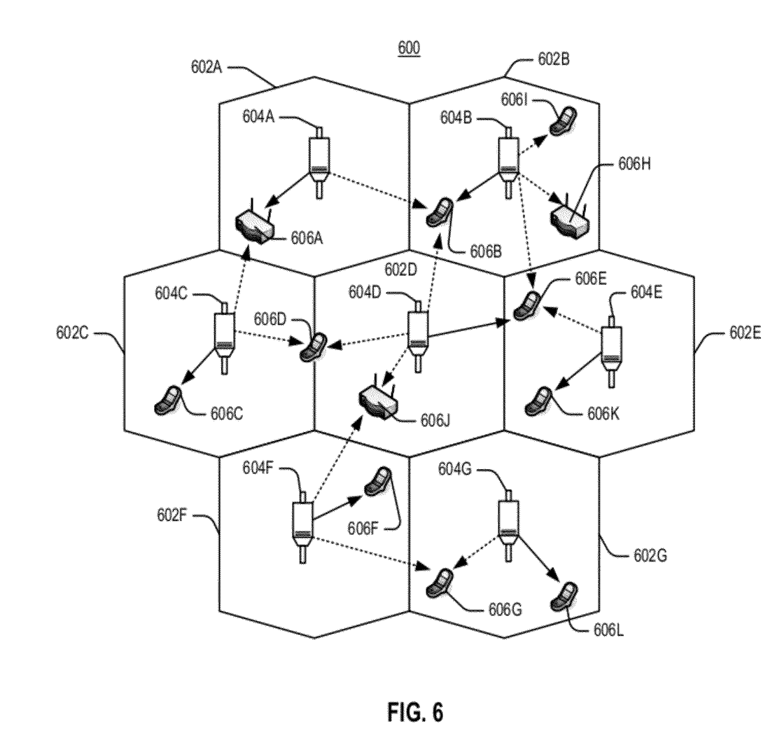

FIG. 6 illustrates a wireless communication system 600, configured to support a number of users, in which the teachings herein may be implemented. The system 600 provides communication for multiple cells 602, such as, for example, macro cells 602A-602G, with each cell being serviced by a corresponding access point 604 (e.g., access points 604A-604G). As shown in FIG. 6, access terminals 606 (e.g., access terminals 606A-606L) may be dispersed at various locations throughout the system over time. Each access terminal 606 may communicate with one or more access points 604 on a forward link (FL) and/or a reverse link (RL) at a given moment, depending upon whether the access terminal 606 is active and whether it is in soft handoff, for example. The wireless communication system 600 may provide service over a large geographic region. For example, macro cells 602A-602G may cover a few blocks in a neighborhood or several miles in a rural environment.

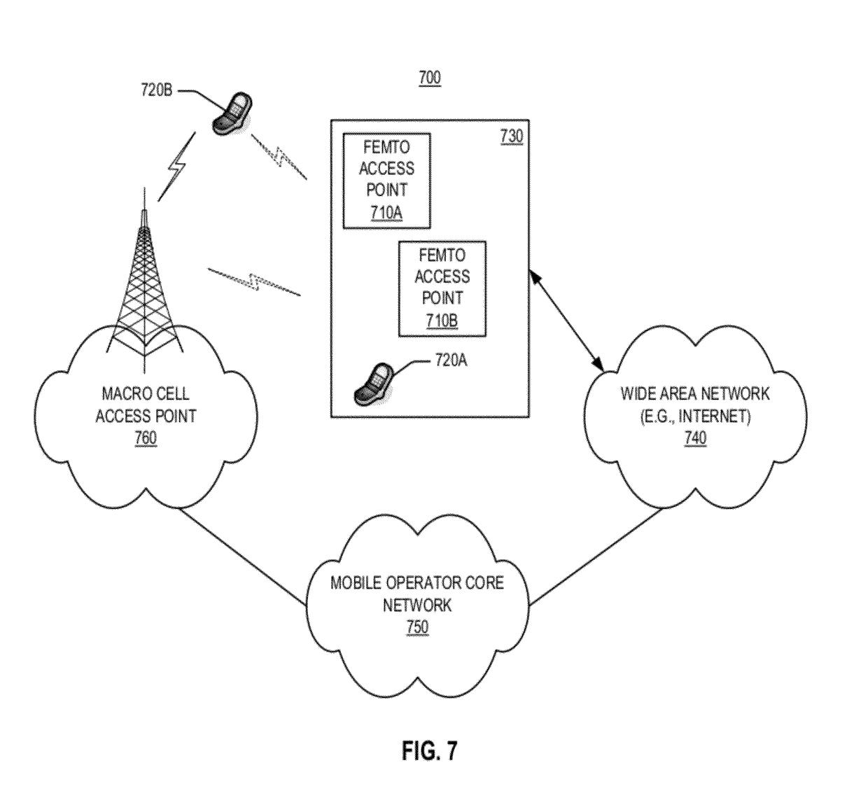

FIG. 7 illustrates an exemplary communication system 700 where one or more femto access points are deployed within a network environment. Specifically, the system 700 includes multiple femto access points 710 (e.g., femto access points 710A and 710B) installed in a relatively small scale network environment (e.g., in one or more user residences 730). Each femto access point 710 may be coupled to a wide area network 740 (e.g., the Internet) and a mobile operator core network 750 via a DSL router, a cable modem, a wireless link, or other connectivity means (not shown). As will be discussed below, each femto access point 710 may be configured to serve associated access terminals 720 (e.g., access terminal 720A) and, optionally, other (e.g., hybrid or alien) access terminals 720 (e.g., access terminal 720B). In other words, access to femto access points 710 may be restricted whereby a given access terminal 720 may be served by a set of designated (e.g., home) femto access point(s) 710 but may not be served by any non-designated femto access points 710 (e.g., a neighbor's femto access point 710).

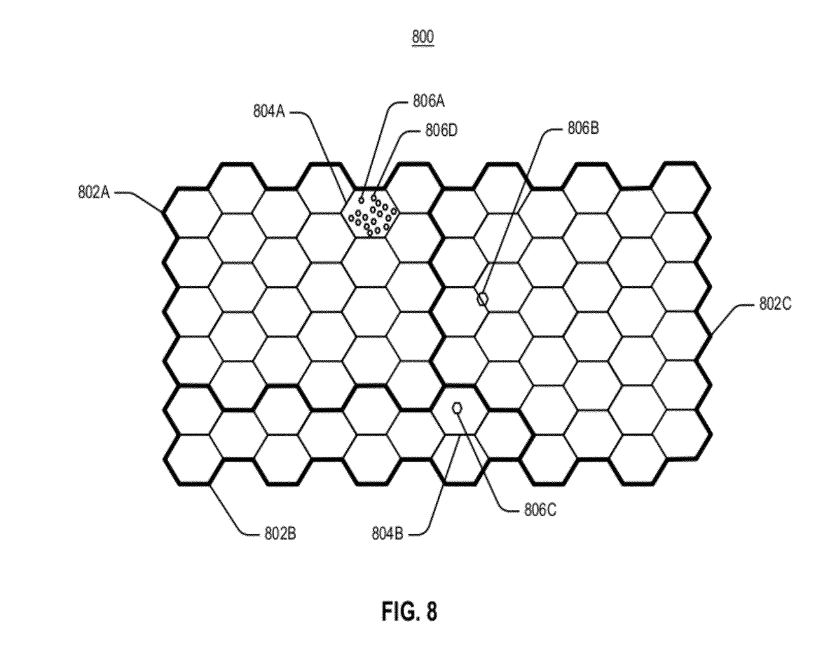

FIG. 8 illustrates an example of a coverage map 800 where several tracking areas 802 (or routing areas or location areas) are defined, each of which includes several macro coverage areas 804. Here, areas of coverage associated with tracking areas 802A, 802B, and 802C are delineated by the wide lines and the macro coverage areas 804 are represented by the larger hexagons. The tracking areas 802 also include femto coverage areas 806. In this example, each of the femto coverage areas 806 (e.g., femto coverage areas 806B and 806C) is depicted within one or more macro coverage areas 804 (e.g., macro coverage areas 804A and 804B). It should be appreciated, however, that some or all of a femto coverage area 806 may not lie within a macro coverage area 804. In practice, a large number of femto coverage areas 806 (e.g., femto coverage areas 806A and 806D) may be defined within a given tracking area 802 or macro coverage area 804. Also, one or more pico coverage areas (not shown) may be defined within a given tracking area 802 or macro coverage area 804.

Referring again to FIG. 7, the owner of a femto access point 710 may subscribe to mobile service, such as, for example, 3G mobile service, offered through the mobile operator core network 750. In addition, an access terminal 720 may be capable of operating both in macro environments and in smaller scale (e.g., residential) network environments. In other words, depending on the current location of the access terminal 720, the access terminal 720 may be served by a macro cell access point 760 associated with the mobile operator core network 750 or by any one of a set of femto access points 710 (e.g., the femto access points 710A and 710B that reside within a corresponding user residence 730). For example, when a subscriber is outside his home, he is served by a standard macro access point (e.g., access point 760) and when the subscriber is at home, he is served by a femto access point (e.g., access point 710A). Here, a femto access point 710 may be backward compatible with legacy access terminals 720.

A femto access point 710 may be deployed on a single frequency or, in the alternative, on multiple frequencies. Depending on the particular configuration, the single frequency or one or more of the multiple frequencies may overlap with one or more frequencies used by a macro access point (e.g., access point 760).

In some aspects, an access terminal 720 may be configured to connect to a preferred femto access point (e.g., the home femto access point of the access terminal 720) whenever such connectivity is possible. For example, whenever the access terminal 720A is within the user's residence 730, it may be desired that the access terminal 720A communicate only with the home femto access point 710A or 710B.

In some aspects, if the access terminal 720 operates within the macro cellular network 750 but is not residing on its most preferred network (e.g., as defined in a preferred roaming list), the access terminal 720 may continue to search for the most preferred network (e.g., the preferred femto access point 710) using a better system reselection (BSR) procedure, which may involve a periodic scanning of available systems to determine whether better systems are currently available and subsequently acquire such preferred systems. The access terminal 720 may limit the search for specific band and channel. For example, one or more femto channels may be defined whereby all femto access points (or all restricted femto access points) in a region operate on the femto channel(s). The search for the most preferred system may be repeated periodically. Upon discovery of a preferred femto access point 710, the access terminal 720 selects the femto access point 710 and registers on it for use when within its coverage area.

Access to a femto access point may be restricted in some aspects. For example, a given femto access point may only provide certain services to certain access terminals. In deployments with so-called restricted (or closed) access, a given access terminal may only be served by the macro cell mobile network and a defined set of femto access points (e.g., the femto access points 710 that reside within the corresponding user residence 730). In some implementations, an access point may be restricted to not provide, for at least one node (e.g., access terminal), at least one of: signaling, data access, registration, paging, or service.

In some aspects, a restricted femto access point (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., femto access points) that share a common access control list of access terminals.

Various relationships may thus exist between a given femto access point and a given access terminal. For example, from the perspective of an access terminal, an open femto access point may refer to a femto access point with unrestricted access (e.g., the femto access point allows access to any access terminal). A restricted femto access point may refer to a femto access point that is restricted in some manner (e.g., restricted for access and/or registration). A home femto access point may refer to a femto access point on which the access terminal is authorized to access and operate on (e.g., permanent access is provided for a defined set of one or more access terminals). A hybrid (or guest) femto access point may refer to a femto access point on which different access terminals are provided different levels of service (e.g., some access terminals may be allowed partial and/or temporary access while other access terminals may be allowed full access). An alien femto access point may refer to a femto access point on which the access terminal is not authorized to access or operate on, except for perhaps emergency situations (e.g., 911 calls).

From a restricted femto access point perspective, a home access terminal may refer to an access terminal that is authorized to access the restricted femto access point installed in the residence of that access terminal's owner (usually the home access terminal has permanent access to that femto access point). A guest access terminal may refer to an access terminal with temporary access to the restricted femto access point (e.g., limited based on deadline, time of use, bytes, connection count, or some other criterion or criteria). An alien access terminal may refer to an access terminal that does not have permission to access the restricted femto access point, except for perhaps emergency situations, for example, such as 911 calls (e.g., an access terminal that does not have the credentials or permission to register with the restricted femto access point).

For convenience, the disclosure herein describes various functionality in the context of a femto access point. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal communicates with one or more access points via transmissions on the forward and reverse links. These communication links may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

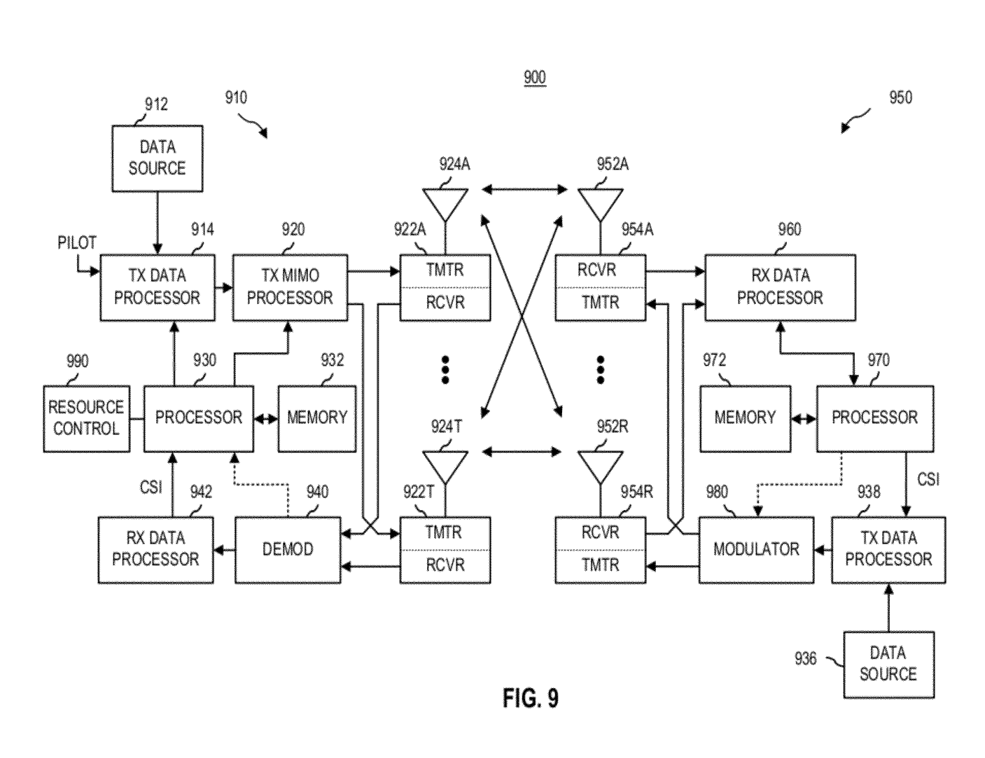

FIG. 9 illustrates a wireless device 910 (e.g., an access point) and a wireless device 950 (e.g., an access terminal) of a sample MIMO system 900. At the device 910, traffic data for a number of data streams is provided from a data source 912 to a transmit (TX) data processor 914. Each data stream may then be transmitted over a respective transmit antenna.

The TX data processor 914 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 930. A data memory 932 may store program code, data, and other information used by the processor 930 or other components of the device 910.

The modulation symbols for all data streams are then provided to a TX MIMO processor 920, which may further process the modulation symbols (e.g., for OFDM). The TX MIMO processor 920 then provides N_{T} modulation symbol streams to N_{T} transceivers (XCVR) 922A through 922T. In some aspects, the TX MIMO processor 920 applies beam-forming weights to the symbols of the data streams and to the antenna from which the symbol is being transmitted.

Each transceiver 922 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 922A through 922T are then transmitted from N_{T} antennas 924A through 924T, respectively.

At the device 950, the transmitted modulated signals are received by N_{R} antennas 952A through 952R and the received signal from each antenna 952 is provided to a respective transceiver (XCVR) 954A through 954R. Each transceiver 954 conditions (e.g., filters, amplifies, and downconverts) a respective received signal, digitizes the conditioned signal to provide samples, and further processes the samples to provide a corresponding “received” symbol stream.

A receive (RX) data processor 960 then receives and processes the N_{R} received symbol streams from N_{R} transceivers 954 based on a particular receiver processing technique to provide N_{T} “detected” symbol streams. The RX data processor 960 then demodulates, deinterleaves, and decodes each detected symbol stream to recover the traffic data for the data stream. The processing by the RX data processor 960 is complementary to that performed by the TX MIMO processor 920 and the TX data processor 914 at the device 910.

A processor 970 periodically determines which pre-coding matrix to use (discussed below). The processor 970 formulates a reverse link message comprising a matrix index portion and a rank value portion. A data memory 972 may store program code, data, and other information used by the processor 970 or other components of the device 950.

The reverse link message may comprise various types of information regarding the communication link and/or the received data stream. The reverse link message is then processed by a TX data processor 938, which also receives traffic data for a number of data streams from a data source 936, modulated by a modulator 980, conditioned by the transceivers 954A through 954R, and transmitted back to the device 910.

At the device 910, the modulated signals from the device 950 are received by the antennas 924, conditioned by the transceivers 922, demodulated by a demodulator (DEMOD) 940, and processed by a RX data processor 942 to extract the reverse link message transmitted by the device 950. The processor 930 then determines which pre-coding matrix to use for determining the beam-forming weights then processes the extracted message.

FIG. 9 also illustrates that the communication components may include one or more components that perform resource control operations as taught herein. For example, a resource control component 990 may cooperate with the processor 930 and/or other components of the device 910 to allocate resources (e.g., for the device 950) as taught herein. It should be appreciated that for each device 910 and 950 the functionality of two or more of the described components may be provided by a single component. For example, a single processing component may provide the functionality of the resource control component 990 and the processor 930.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1×RTT, 1×EV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

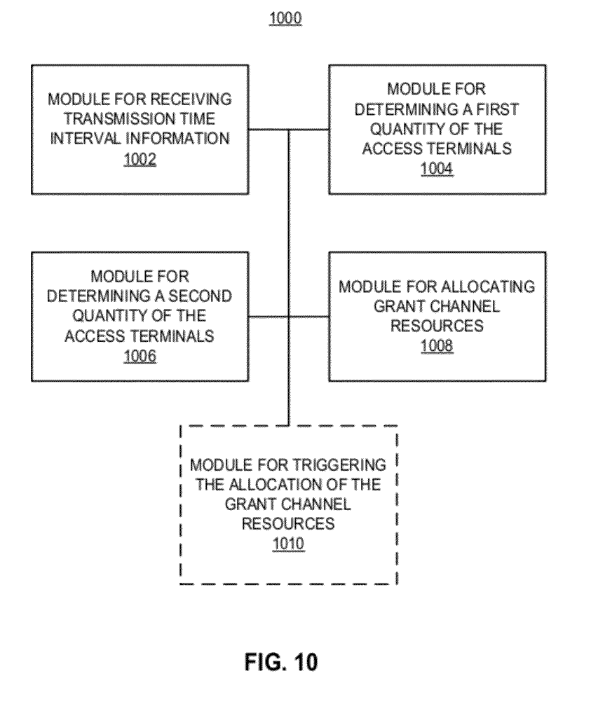

The functionality described herein (e.g., with regard to one or more of the accompanying figures) may correspond in some aspects to similarly designated “means for” functionality in the appended claims. Referring to FIG. 10, an apparatus 1000 is represented as a series of interrelated functional modules. Here, a module for receiving transmission time interval information may correspond at least in some aspects to, for example, a receiver as discussed herein. A module for determining a first quantity of the access terminals 1004 may correspond at least in some aspects to, for example, a controller as discussed herein. A module for determining a second quantity of the access terminals 1006 may correspond at least in some aspects to, for example, a controller as discussed herein. A module for allocating grant channel resources 1008 may correspond at least in some aspects to, for example, a controller as discussed herein. A module for triggering the allocation of the grant channel resources 1010 may correspond at least in some aspects to, for example, a controller as discussed herein.

The functionality of the modules of FIG. 10 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein. In some aspects one or more of any dashed blocks in FIG. 10 are optional.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media. It should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of communication, comprising:
receiving transmission time interval information for a plurality of access terminals;
determining a first quantity of the access terminals that transmit based on a first transmission time interval, wherein the determination of the first quantity is based on the received transmission time interval information;
determining a second quantity of the access terminals that transmit based on a second transmission time interval, wherein the determination of the second quantity is based on the received transmission time interval information; and
allocating grant channel resources of an access point to the access terminals based on the determination of the first and second quantities.

2. The method of claim 1, wherein the allocation of the grant channel resources comprises:
comparing the first and second quantities; and
allocating the grant channel resources based on the comparison.

3. The method of claim 1, wherein the allocation of the grant channel resources is based on a ratio of the first and second quantities.

4. The method of claim 1, wherein, if the first quantity is zero, the allocation of the grant channel resources comprises allocating all of the grant channel resources to the access terminals that transmit based on the second transmission time interval.

5. The method of claim 1, wherein the allocation of the grant channel resources comprises:
allocating the grant channel resources to minimize a maximum delay associated with grant reception at the access terminals, wherein the minimization of the maximum delay is based on the first and second quantities.

6. The method of claim 1, wherein the allocation of the grant channel resources comprises:
allocating the grant channel resources to minimize an average delay associated with grant reception at the access terminals, wherein the minimization of the average delay is based on the first and second quantities.

7. The method of claim 1, further comprising triggering the allocation of the grant channel resources based on a change in a quantity of access terminals served by the access point.

8. The method of claim 1, further comprising triggering the allocation of the grant channel resources based on a change in a quantity of access terminals currently allowed to access the access point.

9. The method of claim 1, wherein:
the first transmission time interval comprises a 2 millisecond interval for high-speed uplink packet access transmissions; and
the second transmission time interval comprises a 10 millisecond interval for high-speed uplink packet access transmissions.

10. The method of claim 1, wherein the grant channel resources comprise grant channels where transmission grant information for different access terminals is sent over each of the grant channels on a time division multiplexed basis.

11. The method of claim 1, wherein the grant channel resources comprise enhanced absolute grant channels.

12. An apparatus for communication, comprising:
a receiver configured to receive transmission time interval information for a plurality of access terminals; and
a controller configured to determine a first quantity of the access terminals that transmit based on a first transmission time interval, and further configured to determine a second quantity of the access terminals that transmit based on a second transmission time interval, wherein the determinations of the first and second quantities are based on the received transmission time interval information, and further configured to allocate grant channel resources of the apparatus to the access terminals based on the determination of the first and second quantities.

13. The apparatus of claim 12, wherein the allocation of the grant channel resources comprises:
comparing the first and second quantities; and
allocating the grant channel resources based on the comparison.

14. The apparatus of claim 12, wherein the allocation of the grant channel resources is based on a ratio of the first and second quantities.

15. The apparatus of claim 12, wherein, if the first quantity is zero, the allocation of the grant channel resources comprises allocating all of the grant channel resources to the access terminals that transmit based on the second transmission time interval.

16. The apparatus of claim 12, wherein the allocation of the grant channel resources comprises:
allocating the grant channel resources to minimize a maximum delay associated with grant reception at the access terminals, wherein the minimization of the maximum delay is based on the first and second quantities.

17. The apparatus of claim 12, wherein the allocation of the grant channel resources comprises:
allocating the grant channel resources to minimize an average delay associated with grant reception at the access terminals, wherein the minimization of the average delay is based on the first and second quantities.

18. The apparatus of claim 12, wherein the controller is further configured to trigger the allocation of the grant channel resources based on a change in a quantity of access terminals served by the apparatus.

19. The apparatus of claim 12, wherein the controller is further configured to trigger the allocation of the grant channel resources based on a change in a quantity of access terminals currently allowed to access the apparatus.

20. The apparatus of claim 12, wherein:
the first transmission time interval comprises a 2 millisecond interval for high-speed uplink packet access transmissions; and
the second transmission time interval comprises a 10 millisecond interval for high-speed uplink packet access transmissions.

21. The apparatus of claim 12, wherein the grant channel resources comprise grant channels where transmission grant information for different access terminals is sent over each of the grant channels on a time division multiplexed basis.

22. The apparatus of claim 12, wherein the grant channel resources comprise enhanced absolute grant channels.

23. An apparatus for communication, comprising:
means for receiving transmission time interval information for a plurality of access terminals;
means for determining a first quantity of the access terminals that transmit based on a first transmission time interval, wherein the determination of the first quantity is based on the received transmission time interval information;
means for determining a second quantity of the access terminals that transmit based on a second transmission time interval, wherein the determination of the second quantity is based on the received transmission time interval information; and
means for allocating grant channel resources of the apparatus to the access terminals based on the determination of the first and second quantities.

24. The apparatus of claim 23, wherein the allocation of the grant channel resources comprises:
comparing the first and second quantities; and
allocating the grant channel resources based on the comparison.

25. The apparatus of claim 23, wherein the allocation of the grant channel resources is based on a ratio of the first and second quantities.

26. The apparatus of claim 23, further comprising means for triggering the allocation of the grant channel resources based on a change in a quantity of access terminals served by the apparatus.

27. The apparatus of claim 23, further comprising means for triggering the allocation of the grant channel resources based on a change in a quantity of access terminals currently allowed to access the apparatus.

28. The apparatus of claim 23, wherein:
the first transmission time interval comprises a 2 millisecond interval for high-speed uplink packet access transmissions; and
the second transmission time interval comprises a 10 millisecond interval for high-speed uplink packet access transmissions.

29. The apparatus of claim 23, wherein the grant channel resources comprise enhanced absolute grant channels.

30. A computer-program product, comprising:
computer-readable medium comprising code for causing a computer to:
receive transmission time interval information for a plurality of access terminals;
determine a first quantity of the access terminals that transmit based on a first transmission time interval, wherein the determination of the first quantity is based on the received transmission time interval information;
determine a second quantity of the access terminals that transmit based on a second transmission time interval, wherein the determination of the second quantity is based on the received transmission time interval information; and
allocate grant channel resources of an access point to the access terminals based on the determination of the first and second quantities.

31. The computer-program product of claim 30, wherein the allocation of the grant channel resources comprises:
comparing the first and second quantities; and
allocating the grant channel resources based on the comparison.

32. The computer-program product of claim 30, wherein the allocation of the grant channel resources is based on a ratio of the first and second quantities.

33. The computer-program product of claim 30, wherein the computer-readable medium further comprises code for causing the computer to trigger the allocation of the grant channel resources based on a change in a quantity of access terminals served by the access point.

34. The computer-program product of claim 30, wherein the computer-readable medium further comprises code for causing the computer to trigger the allocation of the grant channel resources based on a change in a quantity of access terminals currently allowed to access the access point.

35. The computer-program product of claim 30, wherein:
the first transmission time interval comprises a 2 millisecond interval for high-speed uplink packet access transmissions; and
the second transmission time interval comprises a 10 millisecond interval for high-speed uplink packet access transmissions.

36. The computer-program product of claim 30, wherein the grant channel resources comprise enhanced absolute grant channels.
